(19) United States
(12) Patent Application Publication
(10) Pub. No.: US 2015/0062191 A1
(43) Pub. Date: Mar. 5, 2015

(54) METHOD OF DRIVING A LIGHT-SOURCE AND DISPLAY APPARATUS FOR PERFORMING THE METHOD

(71) Applicant: Samsung Display Co., Ltd., Yongin-city (KR)

(72) Inventors: Heen-Dol KIM, Yongin-si (KR); Jai-Hyun KOH, Hwaseong-si (KR); Jin-Pil KIM, Suwon-si (KR); Hyun-Kyu NAMKUNG, Seoul (KR); Seok-Yun SON, Yongin-si (KR); Kuk-Hwan AHN, Hwaseong-si (KR)

(21) Appl. No.: 14/340,177

(22) Filed: Jul. 24, 2014

(30) Foreign Application Priority Data
Sep. 5, 2013 (KR) 10-2013-0106392

(51) Int. Cl. G09G 3/36

(52) U.S. Cl. CPC G09G 3/3648; G09G 2320/02
USPC 345/690

(57) ABSTRACT

A method of driving a light-source which provides a display panel displaying a picture during at least one frame period with light, includes determining a dimming-level configured to control a luminance of the light based on image data, determining whether the dimming-level of a current picture corresponds to a repetition dimming mode based on the dimming-level of a first previous picture, the first previous picture being displayed on the display panel prior to the current picture, and determining the dimming-level of the current picture to a fixed dimming-level in the repetition dimming mode.

This application claims priority from and the benefit of Korean Patent Application No. 10-2013-0106392, filed on Sep. 5, 2013, which is hereby incorporated by reference for all purposes as if fully set forth herein.

### BACKGROUND OF THE INVENTION

1. Field

Exemplary embodiments of the present invention relate to a method of driving a light-source for improving display quality and a display apparatus performing the method.

2. Discussion of the Background

Generally, a liquid crystal display (LCD) apparatus includes an LCD panel displaying images using a light transmittance of a liquid crystal and a backlight unit disposed under the LCD panel and providing light to the LCD panel.

The LCD panel may include an array substrate, a color filter substrate and a liquid crystal layer. The array substrate may include a plurality of pixel electrodes and a plurality of thin-film transistors (TFTs) electrically connected to the pixel electrodes. The color filter substrate generally faces the array substrate and may have a common electrode and a plurality of color filters. The liquid crystal layer may be interposed between the array substrate and the color filter substrate. When an electric field generated between the pixel electrode and the common electrode is applied to the liquid crystal layer, the arrangement of liquid crystal molecules of the liquid crystal layer is altered to change the optical transmissivity of the liquid crystal layer, such that an image is displayed on the LCD panel. The LCD panel displays a white image of a high luminance when an optical transmittance is increased to maximum, and the LCD panel displays a black image of a low luminance when the optical transmittance is decreased to minimum.

In order to decrease power consumption of the backlight unit, a luminance of light generated from the backlight unit may be adjusted based on a grayscale of an image displayed on the LCD panel. When an image data signal is provided to the LCD panel, a luminance control signal adjusted by the image data signal is provided to the backlight unit. However, a response time of the LCD panel responding to the image data signal is delayed when compared to a response time of the backlight unit responding to the luminance control signal. Thus, a blinking is observed because of the response time difference between the LCD panel and the backlight unit.

### SUMMARY OF THE INVENTION

Exemplary embodiments of the present invention provide a method of driving a light-source for improving a display quality of a repetitive image.

Exemplary embodiments of the present invention provide a display apparatus performing the method.

Additional features of the invention will be set forth in the description which follows, and in part will be apparent from the description, or may be learned by practice of the invention.

An exemplary embodiment of the present invention discloses a method of driving a light-source that provides a display panel displaying a picture during at least one frame period with light. The method includes determining a dimming-level configured to control a luminance of the light based on image data, determining whether the dimming-level of a current picture corresponds to a repetition dimming mode based on the dimming-level of a first previous picture, the first previous picture being displayed on the display panel prior to the current picture, and determining the dimming-level of the current picture to a fixed dimming-level in the repetition dimming mode.

An exemplary embodiment of the present invention also discloses a display apparatus. The display apparatus includes a display panel configured to display a picture during at least one frame period, a data driving part configured to drive the display panel utilizing image data, a light-source part configured to provide the display panel with light and a light-source driving part configured to determine a dimming-level controlling a luminance of the light based on the image data, determine whether the dimming-level of a current picture corresponds to a repetition dimming mode based on the dimming-level of a first previous picture, and determine the dimming-level of the current picture to a fixed dimming-level in the repetition dimming mode, the first previous picture being displayed on the display panel prior to the current picture.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a display apparatus according to an exemplary embodiment of the present invention.

FIG. 2 is a block diagram illustrating the light-source driving part of FIG. 1.

FIG. 3 is a block diagram illustrating the timing control part of FIG. 1.

FIGS. 4A, 4B, and 4C are diagrams illustrating an operation of the repetition determining part of FIG. 2.

FIG. 5 is a flowchart illustrating the method of driving a light-source part shown in FIG. 1.

FIG. 6 is a diagram illustrating the method of driving the light-source part shown in FIG. 5.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

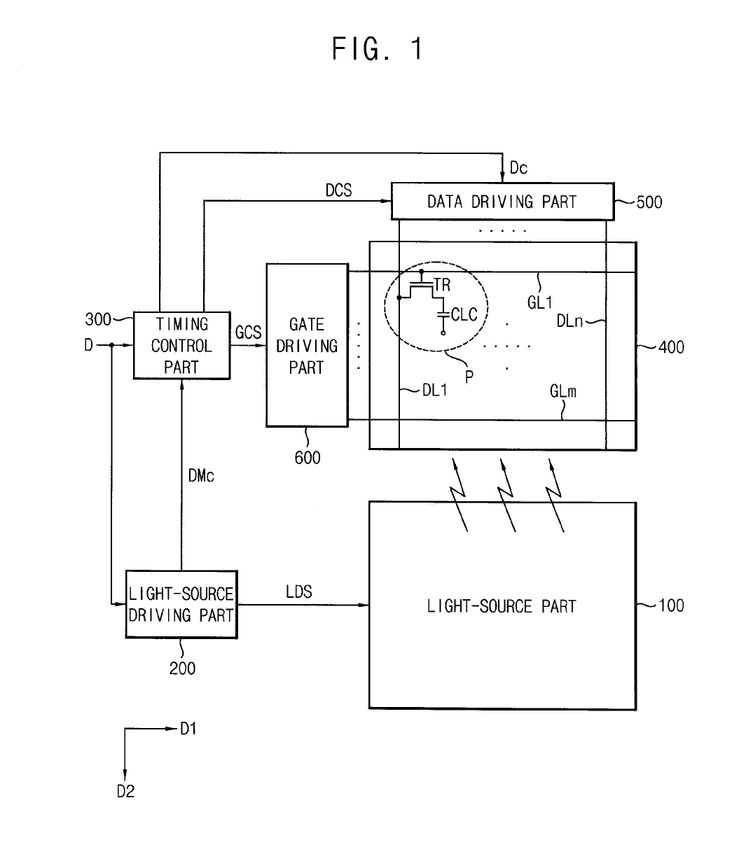

FIG. 1 is a block diagram illustrating a display apparatus according to an exemplary embodiment.

Referring to FIG. 1, the display apparatus may include a light-source part 100, a light-source driving part 200, a timing control part 300, a display panel 400, a data driving part 500, and a gate driving part 600.

The light-source part 100 provides the display panel 400 with light. The light-source part 100 may be of a direct-illumination type or an edge-illumination type. If the light-source part 100 is a direct-illumination type, it may include at least one light-source that generates the light and is disposed under the display panel 400. However, if the light-source part 100 is an edge-illumination type, it may include a light guide plate (LGP) that guides the light toward the display panel 400 and at least one light-source that is disposed at an edge of the LGP. In addition, the light-source part may include at least one light-emitting block that is individually driven in a local dimming mode.

The light-source driving part 200 provides the light-source part 100 with a driving signal LDS. The light-source driving part 200 generates a dimming-level signal to control a luminance of the light which is applied to the display panel 400, based on image data D. The light-source driving part 200 may correct the dimming-level through temporal and spatial low pass filers to generate corrected dimming-level signal DMc. The light-source driving part 200 generates a driving signal LDS utilizing the corrected dimming-level signal DMc to drive the light-source part 100, providing the light-source part 100 with the driving signal LDS. In addition, the light-source driving part 200 may provide the timing control part 300 with the corrected dimming-level signal DMc.

The light-source driving part 200 is configured to determine whether a picture displayed on the display panel 400 is a repetitive picture. A repetitive picture is a picture that is repeated according to a period. When the picture is the repetitive picture, the light-source driving part 200 drives the light-source part 100 using a fixed dimming-level. Thus, when the display panel 400 displays the repetitive picture, the light-source part 100 generates a light of fixed luminance corresponding to the fixed dimming-level. Therefore, display degradation, such as a crawling, a blinking, etc., occurring by a response-time difference between the display panel 400 and the light-source part 100 may be reduced.

The timing control part 300 may control the driving timing of the display apparatus. For example, the timing control part 300 may generate a data control signal DCS configured to control the data driving part 500 and a gate control signal GCS configured to control the gate driving part 600.

In addition, the timing control part 300 may receive the corrected dimming-level signal DMc from the light-source driving part 200 and correct the image data D based on the corrected dimming-level DMc to provide the data driving part 500 with corrected image data Dc.

The display panel 400 may include a plurality of gate lines GL1 to GLm, a plurality of data lines DL1 to DLn and a plurality of pixels P. The gate lines GL1 to GLm may extend in a first direction D1. The data lines DL1 to DLn may extend in a second direction D2, crossing the first direction D1. Each of the pixels P includes a switching element TR, which is electrically connected to a gate line and a data line, and a liquid crystal capacitor CLC, which is connected to the switching element TR.

The data driving part 500 may be electrically connected to end portions of the data lines DL1 to DLn. The data driving part 500 converts the corrected image data Dc received from the timing control part 300 to a grayscale voltage and provides the data lines DL1 to DLn with the grayscale voltages based on the data control signal DCS.

The gate driving part 600 may be electrically connected to end portions of the gate lines GL1 to GLm. The gate driving part 600 generates a plurality of gate signals utilizing the gate control signal GCS received from the timing control part 300 and gate-on and gate-off voltages received from a voltage generating part (not shown). The gate driving part 600 sequentially provides the gate lines GL1 to GLm with gate signals.

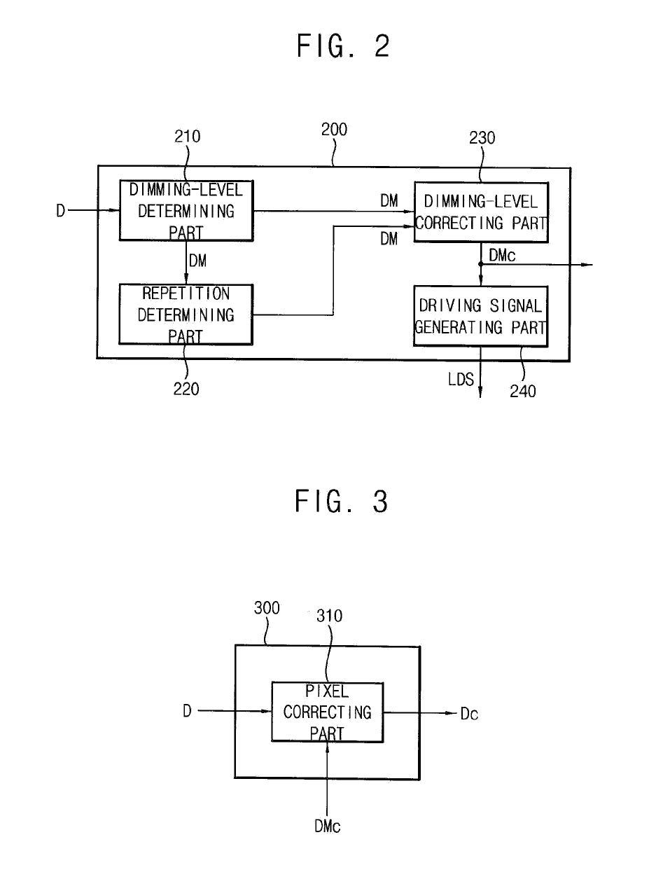

FIG. 2 is a block diagram illustrating a light-source driving part shown in FIG. 1. FIG. 3 is a block diagram illustrating a timing control part shown in FIG. 1.

Referring to FIGS. 1, 2, and 3, the light-source driving part 200 may include a dimming-level determining part 210, a repetition determining part 220, a dimming-level correcting part 230 and a driving signal generating part 240.

The dimming-level determining part 210 calculates a representative grayscale of a current frame utilizing a histogram based on the image data D of the current frame. The dimming-level determining part 210 determines a dimming-level DM of the light-source part 100 utilizing the representative grayscale.

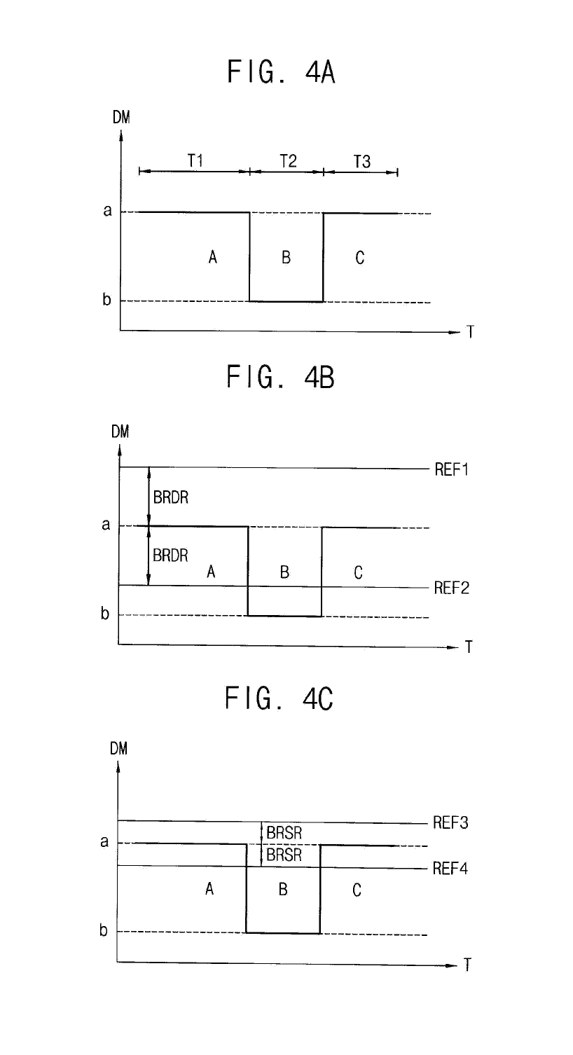

The repetition determining part 200 determines whether the dimming-level DM of a current picture received from the dimming-level determining part 210 is a dimming-level of a repetition dimming mode which is repeated by a period. When the dimming-level DM of the current picture corresponds to the repetition dimming mode, the repetition determining part 200 determines the dimming-level of the current picture as a fixed dimming-level. A method of driving the repetition determining part 200 will be explained referring to FIGS. 4A to 4C.

According to the present exemplary embodiment, when the dimming-level DM of the current picture corresponds to a normal dimming mode, the light-source part 100 is driven based on the dimming-level DM. In this case, the dimming-level DM is determined from the dimming-level determining part 210 to generate the light of the luminance corresponding to the dimming-level DM. Alternatively, when the dimming-level DM of the current picture corresponds to the repetition dimming mode, the light-source part 100 is driven based on the fixed dimming-level DM determined from the repetition determining part 200 to generate the light of the luminance corresponding to the fixed dimming-level DM.

The dimming-level correcting part 230 corrects the dimming-level received from the dimming-level determining part 210 or the repetition determining part 220 through the temporal and the spatial low pass filers and outputs corrected dimming-level signal DMc.

The driving signal generating part 240 generates the driving signal LDS utilizing the corrected dimming-level DMc to drive the light-source part 100, and provides the light-source part 100 with the driving signal LDS.

The timing control part 300 may include a pixel correcting part 310. The pixel correcting part 310 corrects the image data D based on the corrected dimming-level signal DMc received from the light-source driving part 200 to generate corrected image data Dc. For example, when the corrected dimming-level DMc has a high level corresponding to a high luminance, the image data D are corrected as corrected image data Dc which have a grayscale level lower than a grayscale level of the image data. However, when the corrected dimming-level DMc has a low level corresponding to a low luminance, the image data D are corrected as corrected image data Dc which have the grayscale level higher than the grayscale level of the image data. Thus, electric power consumption for driving the display panel 400 may be decreased.

FIGS. 4A, 4B and 4C are conceptual diagrams illustrating an operation of a repetition determining part shown in FIG. 2.

Referring to FIGS. 1, 2, 4A, 4B and 4C, a method of determining a repetition dimming mode will be explained hereinafter.

A current picture ‘C’ corresponds to the image data that is currently received. A first previous picture ‘B’ is displayed on the display panel 400 prior to the current picture ‘C’. A second previous picture ‘A’ is displayed on the display panel 400 prior to the first previous picture ‘B’. The picture A, B or C may include at least one frame image which is displayed on the display panel 400 during one frame.

As shown in FIG. 4A, the dimming-level determining part 210 determines the dimming-level of the light-source part 100 corresponding to the current picture C as a first dimming-level ‘a’, determines the dimming-level of the light-source part 100 corresponding to the first previous picture B as a second dimming-level ‘b’, and determines the dimming-level of the light-source part 100 corresponding to the second previous picture A as the first dimming-level ‘a’.

When the repetition determining part 220 receives the first dimming-level ‘a’ of the current picture C, the repetition determining part 220 compares the first dimming-level ‘a’ of the current picture C with the second dimming-level ‘b’ of the first previous picture B and determines whether the current picture C is different from the first previous picture B.

For example, when the second dimming-level ‘b’ of the first previous picture B is more than a first reference value REF1 or less than a second reference value REF2, the repetition determining part 220 determines that the current picture C is different from the first previous picture B. When the current picture C is different from the first previous picture B, the repetition determining part 220 stores the first dimming-level ‘a’ of the current picture C, the second dimming-level ‘b’ of the first previous picture B and the first dimming-level ‘a’ of the second previous picture A. The first reference value REF1 (a+BRDR) may be a first allowable value BRDR added to the first dimming-level ‘a’ of the current picture C. The second reference value REF2 (a-BRDR) may be the first allowable value BRDR subtracted from the first dimming-level ‘a’ of the current picture C. The first allowable value BRDR is a parameter that may be stored at a register.

However, when the second dimming-level ‘b’ of the first previous picture B is less than the first reference value REF1 or more than the second reference value REF2, the repetition determining part 220 determines that the current picture C is not a repetitive picture. Thus, the current picture C may be displayed based on the first dimming-level ‘a’ which is determined from the dimming-level determining part 210.

The repetition determining part 220 then compares the first dimming-level ‘a’ of the current picture C with the first dimming-level ‘a’ of the second previous picture A to determine a repetition dimming mode.

For example, when the first dimming-level ‘a’ of the second previous picture A is less than a third reference value REF3 or more than a fourth reference value REF4, the current picture C is determined as the repetitive picture. The third reference value REF3 (a+BRSR) may be a second allowable BRSR value added to the first dimming-level ‘a’ of the current picture C. The fourth reference value REF4 (a−BRSR) may be the second allowable value BRSR subtracted from the first dimming-level ‘a’ of the current picture C. The second allowable value BRSR a parameter that may be stored at the register.

However, when the first dimming-level ‘a’ of the second previous picture A is more than the third reference value REF3 or less than the fourth reference value REF4, the repetition determining part 220 determines that the current picture C is not the repetitive picture. Thus, the current picture C may be displayed based on the first dimming-level ‘a’ which is determined from the dimming-level determining part 210.

As shown in FIG. 4C, when the dimming-level is repeated as a first repetition pattern (a→b→a), a first flag may be set, when the dimming-level is repeated as a second repetition pattern (a→b→a→b), a second flag may be set and when the dimming-level is repeated as a third repetition pattern (a→b→a→b→a), a third flag may be set. The repetition pattern of the repetition dimming mode may be selected by a selection parameter which is stored at the register. For example, when the selection parameter stored at the register is the first flag, the repetition determining part 220 determines the repetition dimming mode if the dimming-levels received from the dimming-level determining part 210 are repeated as the first repetition pattern (a→b→a).

When the repetition dimming mode is determined, the repetition determining part 220 determines the dimming-level of the current picture C based on the fixed dimming-level, which is unrelated to the dimming-level received from the dimming-level determining part 210. The fixed dimming-level may be set as one of the dimming-levels of the current picture and the first previous picture. For example, the fixed dimming-level may be set as a maximum or a minimum of the first dimming-level ‘a’ of the current picture C and the second dimming-level ‘b’ of the first previous picture B. The fixed dimming-level may also correspond to a level parameter stored at the register. For example, when the level parameter is ‘1’, the fixed dimming-level may be the first dimming-level ‘a’ which is the maximum of the first dimming-level of the current picture and the second dimming-level of the first previous picture. When the level parameter is ‘0’, the fixed dimming-level may be the second dimming-level which is the minimum of the first dimming-level of the current picture and the second dimming-level of the first previous picture.

When the repetition dimming mode is determined, the light-source part 100 is driven by the fixed dimming-level so that the light having fixed luminance corresponding to the fixed dimming-level is provided to the display panel 400 during a repetition dimming period. During the repetition dimming period, the repetition picture is displayed on the display panel 400. In this manner, a display deterioration occurring by a response-time difference between the display panel 400 and the light-source part 100 may be prevented.

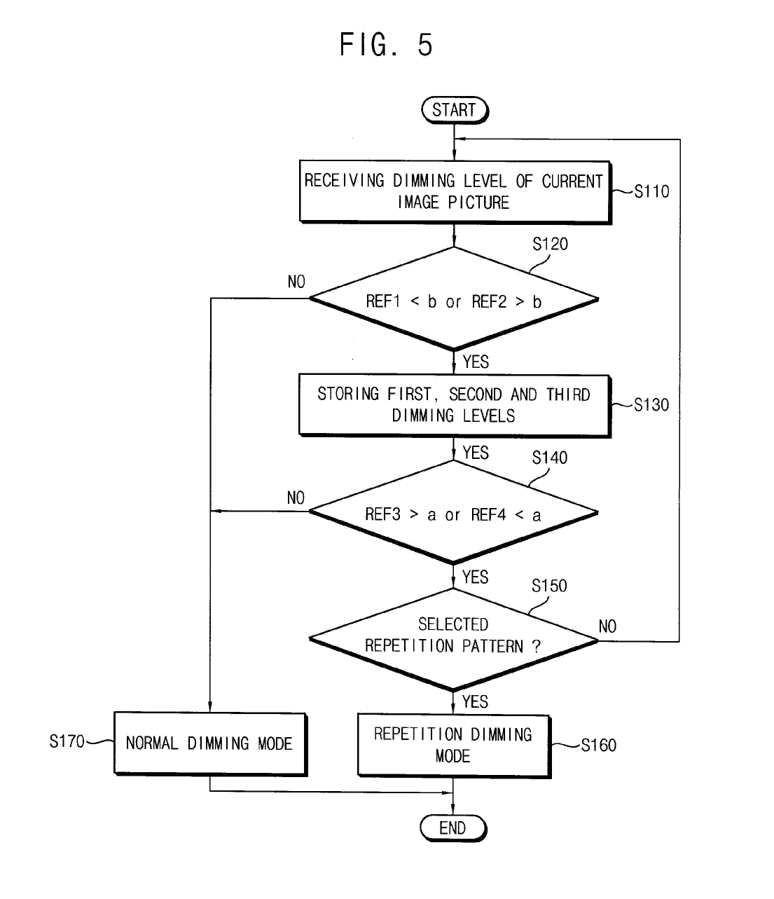

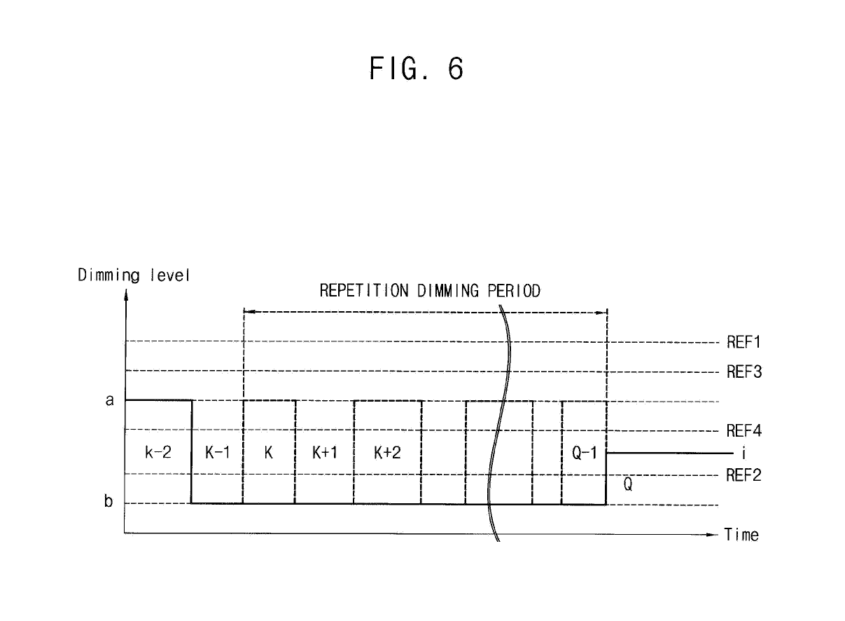

FIG. 5 is a flowchart illustrating the method of driving a light-source part shown in FIG. 1. FIG. 6 is a diagram illustrating the method of driving a light-source part shown in FIG. 5.

Referring to FIGS. 1, 2, 5 and 6, the repetition determining part 220 receives a first dimming-level ‘a’ of a current picture K (step S110).

The repetition determining part 220 compares a second dimming-level ‘b’ of the first previous picture K−1 with first and second reference values REF1 and REF2, respectively (step S120). The first reference value REF1 (a+BRDR) is set as a first allowable value BRDR added to the first dimming-level ‘a’ of the current picture K. The second reference value REF2 (a-BRDR) is set as the first allowable value BRDR subtracted from the first dimming-level ‘a’ of the current picture K. The first allowable value BRDR is a parameter which is stored at a register.

If the dimming-level of the previous picture K−1 is less than the first reference value REF1 or more than the second reference value REF2, the repetition determining part 220 determines that the current picture K is not changed. Thus, the current picture K is driven with a luminance corresponding to a normal dimming mode (step S170).

However, if the second dimming-level ‘b’ of the first previous picture K−1 is more than the first reference value REF1 or less than the second reference value REF2, the repetition determining part 220 determines that the current picture K is changed and then the repetition determining part 220 stores the first dimming-level ‘a’ of the current picture K, the second dimming-level ‘b’ of the first previous picture K−1 and the first dimming-level ‘a’ of the second previous picture K−2 (step S130).

After the first, second, and third dimming levels are stored, the first dimming-level ‘a’ of the current picture K is compared with the first dimming-level ‘a’ of the second previous picture K−2 (step S140).

For example, the first dimming-level ‘a’ of the second previous picture K−2 is less than the third reference value REF3 or more than the fourth reference value REF4, the repetition determining part 220 determines that the current picture K is repeated (step S140). The third reference value REF3 is set as a second allowable BRSR value added to the first dimming-level ‘a’ of the current picture K. The fourth reference value REF4 is set as the second allowable value BRSR subtracted from the first dimming-level ‘a’ of the current picture K. The second allowable value BRSR a parameter which is stored at the register.

However, if the dimming-level of the second previous picture K−2 is more than the third reference value REF3 or less than the fourth reference value REF4, the repetition determining part 220 determines that the current picture K is not the repetitive picture. If this is the case, the current picture K may be driven with the luminance corresponding to the normal dimming mode (step S170).

When the repetition determining part 220 determines that the current picture K is repeated (step S140), the repetition determining part 220 determines a repetition pattern based on the selection parameter stored at the register (step S150).

When the selection parameter is the first flag corresponding to the first repetition pattern (a→b→a), the repetition determining part 220 may drive from the current picture K as the repetition dimming mode (step S160). However, when the selection parameter is the second flag corresponding to the second repetition pattern (a→b→a→b), the repetition determining part 220 may drive from a first next picture K+1 as the repetition dimming mode, and when the selection parameter is the third flag corresponding to the third repetition pattern (a→b→a→b→a), the repetition determining part 220 may drive from a second next picture K+2 as the repetition dimming mode.

In the repetition dimming mode, the repetition determining part 220 determines the dimming-level of the current picture K to be the fixed dimming-level which corresponds to the level parameter stored at the register.

For example, referring to FIG. 6, when the level parameter is ‘0’, the fixed dimming-level may be the first dimming-level ‘a’ which is the minimum of the first dimming-level ‘a’ of the current picture K and the second dimming-level ‘b’ of the first previous picture K−1. Thus, the dimming-level of the current picture K determines the fixed dimming-level ‘b’.

As shown in FIG. 6, the second and first previous picture K−2 and K−1 are being driven in the repetition dimming mode, and thus, the second and first previous picture K−2 and K−1 respectively have the first and second dimming-levels ‘a’ and ‘b’ determined from the dimming-level determining part 210. The current picture K is being driven in the repetition dimming mode, and thus, the current picture K has the second dimming-level b that is the fixed dimming-level determined from the repetition determining part 220. Thus, the light-source part 100 is driven with the second dimming-level b that is the fixed dimming-level during the repetition dimming period wherein the dimming-level is repeated as the repetition pattern (a→b→a).

After the repetition dimming period, a third dimming-level ‘i’ of a current picture Q is received, the repetition determining part 220 compares the third dimming-level ‘i’ of the current picture Q with the first dimming-level ‘a’ of a previous picture Q−1 (step S120). The third dimming-level ‘i’ of the current picture Q is more than the second reference value REF2 so that the repetition determining part 220 determines that the current picture Q is not the repetitive picture. Thus, the current picture Q is driven with the luminance corresponding to the normal dimming mode (step S170).

Therefore, the dimming-level of the current picture Q is held to the third dimming-level ‘i’ determined from the dimming-level determining part 210. Thus, the light-source part 100 provides the display panel 400 with the light of the luminance corresponding to the third dimming-level ‘i’ during a period during which the current picture Q is displayed on the display panel 400.

According to the exemplary embodiments of the present invention, the light-source part provides the display panel with the light of the fixed luminance corresponding to the fixed dimming-level during a period during which the repetitive picture is displayed on the display panel, so that the display degradation, such as crawling, blinking, etc, occurring by a response-time difference between the display panel and the light-source part may be prevented.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of driving a light source, the method comprising:
determining a dimming-level of a current picture based on image data of the current picture;
determining whether the dimming-level of the current picture corresponds to a repetition dimming mode based on the dimming-level of a first previous picture, the first previous picture being an image displayed on the display panel prior to the current picture; and
setting the dimming-level of the current picture to a fixed dimming-level if the dimming-level of the current picture corresponds to the repetition dimming mode.

2. The method of claim 1, wherein the determining whether the dimming-level of the current picture corresponds to the repetition dimming mode comprises:
comparing a first dimming-level of the current picture with a second dimming-level of the first previous picture to determine whether the current picture is changed; and
comparing the first dimming-level with a third dimming-level of a second previous picture to determine whether the current picture is repeated, the second previous picture being an image displayed on the display panel prior to the first previous picture.

3. The method of claim 2, further comprising:
determining that the current picture is changed from the previous picture, when the second dimming-level is more than a first reference value or less than a second reference value.

4. The method of claim 3, wherein the first reference value is a first allowable value added to the first dimming-level and the second reference value is the first allowable value subtracted from the first dimming-level.

5. The method of claim 2, further comprising:
determining that the current picture is a repetitive picture, when the third dimming-level is less than a third reference value or is more than a fourth reference value.

6. The method of claim 5, wherein the third reference value is a second allowable value added to the first dimming-level, and the fourth reference value is the second allowable value subtracted from the first dimming-level.

7. The method of claim 2, further comprising:
storing the first, second, and third dimming-levels when the current picture is changed.

8. The method of claim 2, further comprising:
driving the current picture in the repetition dimming mode if the current picture is a repetitive picture.

9. The method of claim 2, wherein the fixed dimming-level is one of the first dimming-level and the second dimming-level.

10. The method of claim 2, wherein the fixed dimming-level is a maximum or a minimum of the first dimming-level and the second dimming-level.

11. A display apparatus comprising:
a display panel configured to display a picture during at least one frame period;
a data driving part configured to drive the display panel utilizing image data;
a light-source part configured to provide the display panel with light; and
a light-source driving part configured to set a dimming-level controlling a luminance of the light based on the image data, determine whether the dimming-level of a current picture corresponds to a repetition dimming mode based on the dimming-level of a first previous picture, and set the dimming-level of the current picture to a fixed dimming-level if in the repetition dimming mode, the first previous picture being an image displayed on the display panel prior to the current picture.

12. The display apparatus of claim 11, wherein the light-source driving part comprises:
a dimming-level determining part configured to set the dimming-level of a current picture based on image data; and
a repetition determining part configured to compare a first dimming-level of the current picture with a second dimming-level of the first previous picture, compare the first dimming-level of the current picture with a third dimming-level of a second previous picture and determine the repetition dimming mode, the second previous picture being displayed on the display panel prior to the first previous picture,
wherein the repetition determining part sets the dimming-level of the current picture to the fixed dimming-level if in the repetition dimming mode.

13. The display apparatus of claim 12, wherein the repetition determining part is configured to store the first, second, and third dimming-levels when the second dimming-level is more than a first reference value and less than a second reference value,
wherein the first reference value is a first allowable value added to the first dimming-level, and the second reference value is the first allowable value subtracted from the first dimming-level.

14. The display apparatus of claim 13, wherein the light source driving part is configured to set the dimming-level of the current picture to the first dimming-level determined from the dimming-level determining part when the second dimming-level is less than the first reference value or more than the second reference value.

15. The display apparatus of claim 12, wherein the repetition determining part is configured to determine the repetition dimming mode, when the third dimming-level is less than a third reference value or more than a fourth reference value,
wherein the third reference value is a second allowable value added to the first dimming-level, and the fourth reference value is the second allowable value subtracted from the first dimming-level.

16. The display apparatus of claim 15, wherein the light source driving part is configured to set the dimming-level of the current picture to the first dimming-level determined from the dimming-level determining part, when the third dimming-level is more than a third reference value or less than the fourth reference value.

17. The display apparatus of claim 12, wherein the repetition determining part sets one of the first dimming-level of the current picture and the second dimming-level of the first previous picture as the fixed dimming-level.

18. The display apparatus of claim 12, wherein the repetition determining part sets a maximum or a minimum of the first dimming-level of the current picture and the second dimming-level of the previous picture as the fixed dimming-level.

19. The display apparatus of claim 12, wherein the light-source driving part further comprises:
a dimming-level correcting part configured to correct the dimming-level received from the dimming-level determining part and the repetition determining part through temporal and spatial low pass filers.

20. The display apparatus of claim 19, further comprises:
a pixel correcting part configured to correct the image data based on corrected dimming-level received from the dimming-level correcting part and provide the data driving part with corrected image data.
